(19) United States
(12) Patent Application Publication
(10) Pub. No.: US 2005/0237997 A1
(43) Pub. Date: Oct. 27, 2005

(54) Method for preserving the sequence of messages in sip/sip-t protocol

(76) Inventor: Klaus Hoffmann, Munchen (DE)

Correspondence Address: Siemens Corporation;Intellectual Property Department, 170 Wood Avenue South, Iselin, NJ, 08830, US

(21) Appl. No.: 10/512,479

(22) PCT Filed: Jun. 11, 2003
(86) PCT No.: PCT/DE03/01942

§ 371 Date: Oct. 22, 2004

(30) Foreign Application Priority Data
Jul. 16, 2002 (DE) 102 32 175.2

(51) Int. Cl. H04L 12/66

(52) U.S. Cl. 370/352; 370/401

(57) ABSTRACT

In the prior art, a BICC or SIP-T protocol is used at the protocol between media gateway controllers. With the latter, the transmission of ISUP messages is explicitly provided with the aid of INFO methods but is problematic in that a portion of the ISUP messages such as USR or APM messages, during the transmission process, have to adhere to a very specific sequence that is necessary to follow during processing on the receive side. Adherence to the sequence, however, does not always occur since these SIP-T/SIP messages can take different paths thereby resulting in the possible occurrence of repetitions or even losses during the transmission process. The invention solves this problem in that a consecutive sequence number is given to these SIP-T/SIP messages by means of which the SIP/SIP-T partner side can reproduce a sequence that is corrupted during the transmission.

### CROSS REFERENCE TO RELATED APPLICATIONS

This application is the US National Stage of International Application No. PCT/DE2003/001942, filed Jun. 11, 2003 and claims the benefit thereof. The International Application claims the benefits of German application 10232175.2 DE filed Jul. 16, 2002, both of the applications are incorporated by reference herein in their entirety.

### FIELD OF INVENTION

This invention relates generally to a communication network transmitting messages across an IP network, and more particularly to sequencing the messages transmitted.

### BACKGROUND OF INVENTION

More recent communications architectures provide for the separation of call processing networks into connection-related servicing units and the transport of bearer information (bearer control). This results in a separation between establishing a connection and establishing the medium or bearer. Bearer information (bearer channel connection) can be transferred with the aid of different high bit-rate transport technologies such as ATM, IP or Frame Relay.

Using separation of this kind, telecommunication services currently provided in narrow-band networks also need to be provided in broadband networks. Subscribers are then connected either directly, for instance using a DSS 1 protocol, or via switching centers (exchanges) in the form of media gateway controllers (MGCs) using for example the ISUP protocol. The bearer information itself is converted via media gateways (MGs) into the transport technology used in each case.

Media gateway control is carried out by duly allotted media gateway controllers (MGCs). Media gateway controllers use standardized protocols such as MGCP or H.248 to control media gateways. Media gateway controllers communicate with each other by means of the ITU standardized BICC protocol (bearer independent call control), itself

Since the BICC protocol represents a development of an ISUP protocol, the relevant components are subsumed into a separate part known as Q.1902.x BICC CS2 protocol (bearer independent call control capability set 2 with a service indicator in the MTP (message transfer part)). The components relevant purely to communication between media gateway controllers are laid down in another part known as Q.765.5 BAT (bearer application transport). This ITU-T standard protocol also describes RTP for IP bearers as bearer technology. For transmission over ATM or IP networks this results in a separation between the signaling information and bearer information used to provide end customers with their usual telecommunications network services.

A protocol suitable for the BICC protocol has been produced by the IETF standardization committee in the shape of the RFC 3204 protocol (=SIP-T protocol). This represents a supplement to the SIP protocol (RFC 2543). In contrast to the SIP protocol, ISUP messages can be transmitted with the aid of the SIP-T protocol. ISUP messages are generally transmitted via tunnels, which can also be thought of as transparent windows. ISUP messages sent by a PSTN subscriber are preferably routed in conjunction with a carrier message (INFO method, RFC 2976) and conveyed to the receiving PSTN subscriber.

Some typical examples of ISUP messages are USR (user-to-user) messages or APM messages. The former describe supplementary information which can be transmitted over a signaling channel in the course of a conversation (PSTN environment). Examples are the exchange of a password or PIN number (personal identification number). It must also be possible to transmit supplementary information of this kind via the SIP-T protocol, since in certain cases there may be an Internet network between a calling PSTN subscriber and a called PSTN subscriber.

As already mentioned, ISUP messages are conveyed via the SIP-T protocol according to the INFO method together with a carrier message (CONTENT TYPE: ISUP). However, the INFO method is simply a form of transport for ISUP messages via the SIP/SIP-T protocol. However, there is a problem because ISUP messages, especially those transmitted according to the INFO method, have to adhere to a well-defined sequence during processing on the receive side. This is the case with the APM and USR messages mentioned. This problem arises when these messages are sent by the calling PSTN subscriber when using SIP/SIP-T via for example a UDP protocol (which may be used as the carrier for the SIP/SIP-T protocol), and there may then be repetitions or losses during the transmission process in the Internet, since different paths may be provided for the messages. Problems can arise just by using a UDP protocol, since in contrast to the TCP/IP protocol, adherence to a sequence is not guaranteed. A suitable solution to this problem is not provided by the IETF standard for the INFO method (RFC 2976). On the contrary, the problem is dismissed as being of little importance in this document (“ISUP to SIP mapping”, draft IETF sipping ISUP 02, chapter 12.1).

### SUMMARY OF INVENTION

An object of the invention is to develop the transport of ISUP messages via MGC-MGC communication so as to guarantee a more reliable means of transporting ISUP messages.

The object of the invention is achieved on the basis of the features specified in the preamble of the claims and by the features claimed in the characterizing part.

The advantage of the invention lies in the fact that the receive side processing of ISUP messages transmitted according to the INFO method is guaranteed to be in the correct sequence. In this instance ISUP messages are considered to be USR or APM messages, which is not in any sense restrictive, since many national forms of ISUP exist throughout the world. According to the invention, ISUP messages that are going to be transmitted according to the INFO method are given a sequence number at the start of the transmission process. In addition to these solutions for the USR and APM transport mechanism, the introduction of this method also provides a guarantee for the DSS1/ISUP features UUS2 and UUS3 (ITU-T Q.737), in which the subscriber is allowed to send a plurality of user-to-user messages. The extension for INFO then guarantees the correct sequence for this ISDN service also, and can be offered to customers even in the case of SIP-T (MGC-MGC communication).

The invention will be explained in greater detail with the aid of an embodiment which is illustrated in the accompanying diagrams.

### BRIEF DESCRIPTION OF THE DRAWINGS

These show the following:

FIG. 1 The basic inter-relationships between 2 PSTN subscribers between whom an Internet network exists,

FIG. 2 A first illustration of an exchange of protocol elements,

FIG. 3 A second illustration of an exchange of protocol elements,

FIG. 4 A third illustration of an exchange of protocol elements,

FIG. 5 A fourth illustration of an exchange of protocol elements,

FIG. 6 A table showing the fields in which the sequence numbers Rseq and RACK can be conveyed, with the parts marked in bold indicating the extensions.

### DETAILED DESCRIPTION OF INVENTION

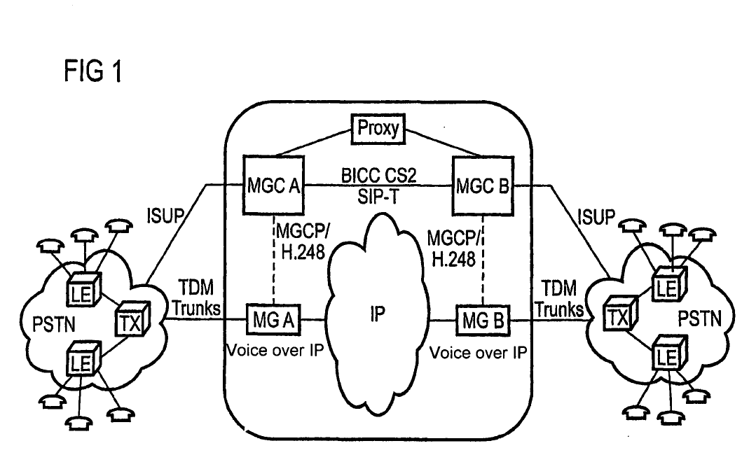

FIG. 1 shows a network configuration in which the method to which the invention relates takes place. Two PSTN networks are shown by way of example, and in each of these a plurality of PSTN subscribers are arranged in a known way. These subscribers can be connected to local exchanges LE which for their part are connected to transit exchanges TX.

The separation between signaling information and bearer information is then carried out in the transit exchanges TX. The signaling information is immediately supplied by the transit exchange TX via an ISUP protocol to the respectively assigned media gateway controller MGC (MGC A or MGC B). The bearer information is sent to a media gateway MG (MG A or MG B) arranged on the input side, this gateway acting as the interface between the TDM network and an ATM or IP transmission network, and the bearer information is transmitted over the transmission network concerned by packet-oriented means. The media gateway MG A is controlled by the media gateway controller MGC A and the media gateway MG B is controlled by the media gateway controller MGC B. In the event of bearer information being transmitted by the media gateway MG A to the media gateway MG B, the bearer information is converted back into a TDM data stream under the control of the media gateway controller MGC B associated with the media gateway MG B and supplied to the PSTN subscriber concerned.

The data transmitted between the media gateway controller MGC and the respectively assigned media gateway is supported by a standardized protocol. This may be for example the MGCP protocol or the H.248 protocol. The further standardized protocol provided between the two media gateway controllers MGC A, MGC B shall now be the SIP or SIP-T protocol instead of a BICC protocol. The SIP-T protocol is used for preference in the attached embodiment. Still further devices such as proxies can be installed between both media gateway controllers.

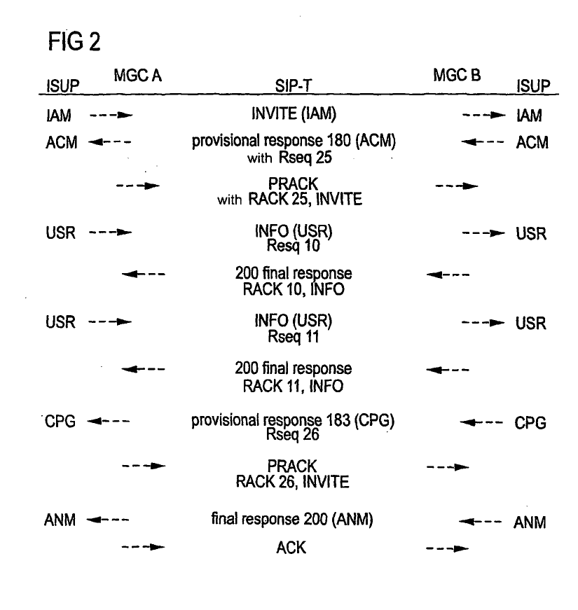

The description which follows is based on the assumption that a PSTN subscriber on the A side sends ISUP messages to a called PSTN subscriber on the B side. FIG. 2 lists the method of proceeding according to the invention. The A side PSTN subscriber first signals a connection request to the B side PSTN subscriber. The intention is that special ISUP messages such as USR messages will be exchanged over the signaling channel during the connection. Both PSTN subscribers are in the PSTN environment, where an exchange of this sort over the ISUP protocol signaling channel is possible. In this case, however, the connection between the two subscribers is conducted via an Internet network IP with the aid of the SIP-T protocol, where this signaling channel (i.e. ISUP) is not available.

According to FIG. 2 an IAM (initial address message), that is a call request, is first sent to the called PSTN subscriber (B side). This call request defines the subscriber with whom the calling subscriber wishes to communicate, that is, it contains the subscriber number. This message is converted into a SIP-T protocol message INVITE in the A side media gateway controller MGC A and transmitted over the Internet network IP. This message is converted back into an ISUP message IAM in the B side media gateway controller MGC B and supplied to the called PSTN subscriber. Thereafter the called PSTN subscriber transfers an ISUP message ACM (address complete message) back towards the calling PSTN subscriber. This message is converted into a SIP-T protocol PROVISIONAL RESPONSE 180 message in the media gateway controller MGC B and together with a sequence number R_{seq}25 is transmitted over the Internet network IP towards the calling PSTN subscriber. The sequence number R_{seq} can be any value and in this case is 25.

The calling PSTN subscriber then receives this message once it has been converted back into the original ISUP message in its associated media gateway controller MGC A. The received SIP-T message is simultaneously acknowledged in the media gateway controller MGC A according to the PRACK method (PROVISIONAL RESPONSE ACKNOWLEDGE). For this purpose the received message PROVISIONAL RESPONSE 180 is to some extent partially mirrored and supplied to the called media gateway controller MGC B in a field RACK with the sequence number R_{seq}25 and the protocol element INVITE.

The description below is based on the assumption that the calling (A side) PSTN subscriber wishes to transmit USR messages (or APM messages) to the called (B side) PSTN subscriber (FIG. 2). For this the USR message is conveyed for example via the media gateway controller MGC A, where it is inserted in the SIP-T protocol into a special field, the (CONTENT TYPE: ISUP) field, and sent during the transmission process.

Still according to the invention, this message is allocated a sequence number R_{seq} which is transmitted with it, being in this embodiment the (reissued) sequence number R_{seq}10. On arriving in the media gateway controller MGC B the INFO message is acknowledged to the media gateway controller MGC A as the message 200 FINAL RESPONSE, the sequence number R_{seq}10 from the INFO message being stored in the field RACK.

Thereafter further USR messages can be exchanged between the calling and called subscribers. Let us assume for instance that the whole message packet contains a total of 10 messages. Each of these messages is allocated a consecutive sequence number on the send side starting with sequence number R_{seq}10 to R_{seq}11, so that the B side media gateway controller MGC B can build up the correct sequence of messages and convey them to the associated subscriber. Messages that arrive in the wrong sequence due to message repetitions are deleted. Since these messages are then unacknowledged, the message is retransmitted by the called subscriber and if it arrives in the right sequence it is processed and acknowledged by the calling subscriber.

In this connection the called PSTN subscriber can then initiate a service feature. In this example it is going to be the call diversion feature. A message CPG representing this feature is sent by the called PSTN subscriber to the calling PSTN subscriber. In the SIP-T protocol this message is converted into a PROVISIONAL RESPONSE 183 message with the sequence number R_{seq}26, and this message is acknowledged between both media gateway controllers MGC A, MGC B according to the PRACK method (with RACK 26). The message exchange is ended by means of a message FINAL RESPONSE 200 (ANM, answer message, Subscriber has picked up) sent by the called subscriber to the calling subscriber. Even if the further B-side PSTN subscriber to whom the call was diverted also carries out a call diversion to a third subscriber, and this subscriber does the same to yet another and so on, the method still works. In such cases the sequence number R_{seq}26 continues to be incremented until the last subscriber initiates no further call diversion.

The basic method is that ISUP messages are sent to the called subscriber before that subscriber has picked up, and the subscriber can receive them in the correct sequence. The advantage of proceeding in this way therefore is that in the SIP-T protocol the sequence of ISUP messages transmitted according to the INFO method is taken into consideration, thereby preventing the connection from being cleared down at the PSTN end point.

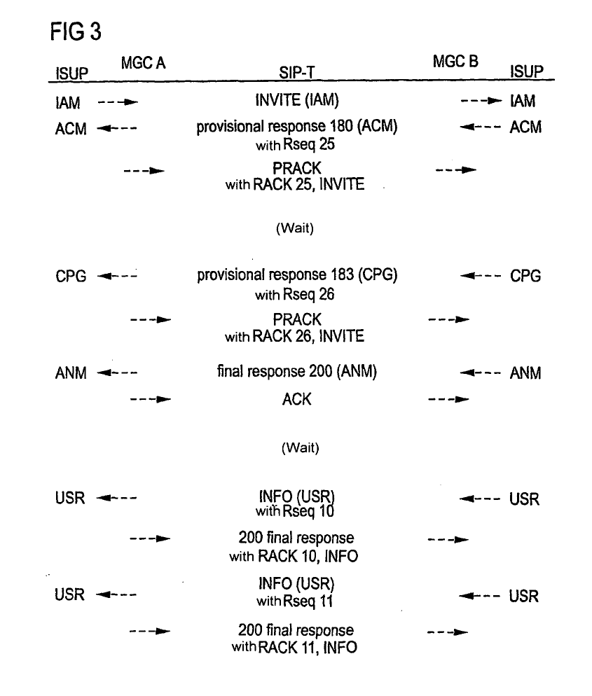

FIG. 3 then shows an example of the inter-relationships if the B-side PSTN subscriber first picks up the line and then exchanges USR messages. In this case, before the call is picked up a call diversion will have been initiated by the subscriber who was called in the first place. The basic inter-relationships shown in FIG. 2 therefore change their sequence. The significant point here is that after sending the FINAL RESPONSE 200 (ANM) message the MGC B must wait until the message is acknowledged with ACK. This is the only way in which the MGC B can be certain when it sends a USR message that this message does not duplicate the FINAL RESPONSE 200 (ANM) message.

The introduction of a wait cycle must basically be thought of as an alternative method. The side which sends the INFO message waits until the “200 OK” message relating to this INFO message has been received (since the 200 OK confirms receipt of the INFO), before the next INFO message is sent. In this case the inclusion of a sequence number is not necessary, but is dynamically more unfavorable.

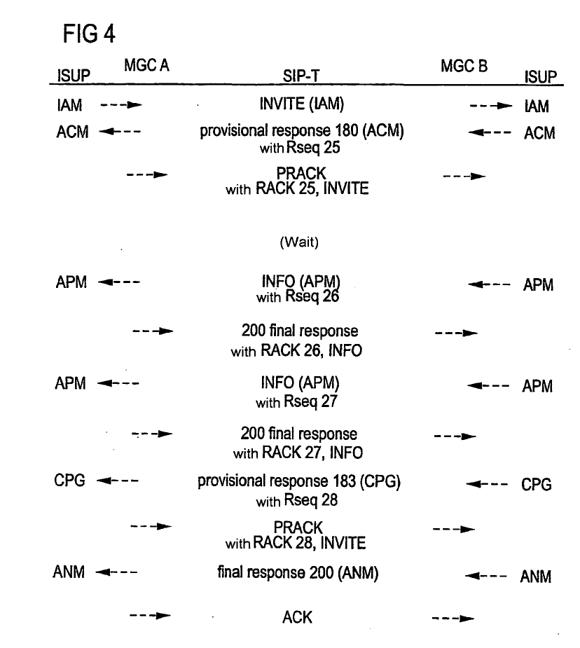

FIG. 4 shows an example in which the MGC B either waits (as described in the example of FIG. 3), or also resorts to (dynamically more favorable) measures to avoid repetitions. In this instance the APM message at the A side (in this example APM messages are referred to instead of USR messages) must not be transmitted before the ACM message. One possibility is to introduce a wait cycle (that is, the B side always waits until the acknowledgement has come). Alternatively the B side can count the sequence number R_{seq} as 26 in order to preserve the sequence. This has the advantage that transmission is considerably more favorable from the dynamic point of view.

The same applies to the inter-relationships shown in FIG. 5. In this example it is not intended to introduce an additional wait cycle. According to this the sequence numbers are not re-issued when the APM messages are transmitted, but instead are incremented even in the case of the 200 OK (ANM) for the INVITE. According to the invention, receipt is then confirmed in the ACK and the Rack is mirrored, thus preserving the correct sequence.

Deviating from the previous standard, the provisional response and the associated PRACK (in which the sender can transmit any starting number) define that the first starting number must always be “1”. The receiver then recognizes that this is the first message in a sequence, which it must acknowledge. However if due to repetition (or loss) it receives a 2, it should and/or can and/or must ignore this message. The repetition mechanism already known in the SIP standard deals with a repetition, and the first message will then arrive at some time or other before the second message. This could even be accepted as an improvement for the provisional responses mechanism. In any case this could be used for the INFO from A to B or for the INFO from B to A if one did not “go along with” the previously used number of the provisional response.

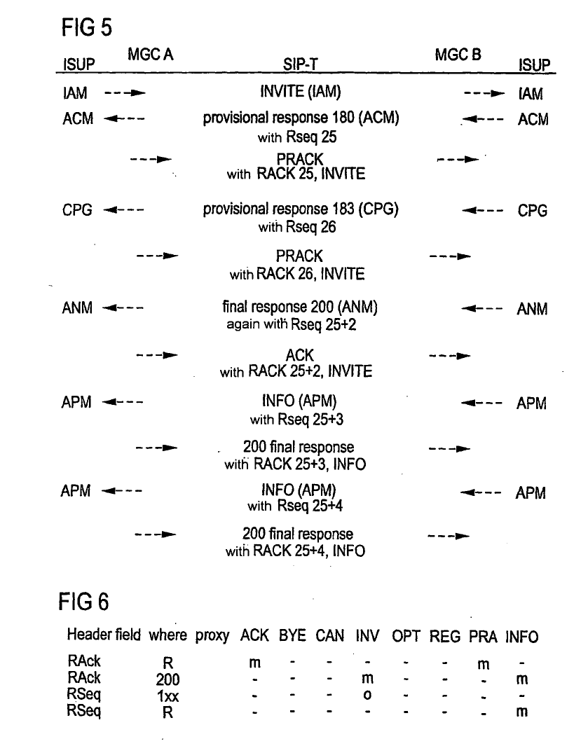

FIG. 6 then shows the fields in which the sequence numbers Rseq are transmitted. The letter o means optional and m means mandatory.

1-6. (canceled)

7. A method for transmitting a message in a communications network, comprising:
providing a plurality of subscribers in the communications network;
providing a first media gateway controller and a second media gateway controller, each media gateway controller controlling a media gateway;
transmitting a session message in an IP network included in the communications network;
allocating a sequence number in the session message;
sending the session message including bearer information via the first media gateway;
reproducing the sequence number by the second media gateway controller; and
providing a sequence number option, the sequence number determined by a method selected from resetting the sequence number to an initial value and incrementing the sequence number.

8. The method according to claim 7, wherein the subscribers are selected from the group consisting of PSTN subscriber, mobile radio subscribers and combinations thereof.

9. The method according to claim 7, wherein the message is selected from the group consisting of ISUP and BICC.

10. The method according to claim 7, wherein the message is an ISUP message selected from the group consisting of USR and APM.

11. The method according to claim 7, wherein the reproduced sequence number is returned in an acknowledgement message.

12. The method according to claim 7, wherein the session message is selected from the group consisting of SIP and SIP-T.

13. The method according to claim 12, wherein the session message includes an INFO session method.

14. The method according to claim 12, wherein the initial value is 1, the initial value is applied to the session message, and the session message includes a session method selected from the group consisting of INFO and PRACK.

15. A method for transmitting a message in a communications network, comprising:
providing a plurality of subscribers in the communications network;
providing a first media gateway controller and a second media gateway controller, each media gateway controller controlling a media gateway;
transmitting a session message in an IP network in the communications network;
sending the session message including bearer information via the first media gateway; and
waiting to send a subsequent session message until the first media gateway receives an acknowledgement to the session message.

16. The method according to claim 15, wherein the subscribers are selected from the group consisting of PSTN subscriber, mobile radio subscribers and combinations thereof.

17. The method according to claim 15, wherein the message is selected from the group consisting of ISUP and BICC.

18. The method according to claim 15, wherein the message is an ISUP message selected from the group consisting of USR and APM.

19. The method according to claim 15, wherein the session message is selected from the group consisting of SIP and SIP-T.

20. The method according to claim 19, wherein the session message includes an INFO session method.

21. A first media gateway controller and a second media gateway controller included in a communications network, comprising:
a plurality of subscribers in the communications network, the subscribers selected from the group consisting of PSTN subscriber, mobile radio subscribers and combinations thereof;
an IP network in the communications network;
a session message transmitted in the IP network to the first media gateway controller, the session message including bearer information;
a sequence number included in the session message by the first media gateway controller, reproduced by the second media gateway controller, and returned in an acknowledgement message; and
a sequence number option providing a method selected from the group consisting of resetting the sequence number to an initial value and incrementing the sequence number,
wherein each media gateway controller controls a media gateway.

22. The communications network according to claim 21, wherein the message is selected from the group consisting of ISUP and BICC.

23. The communications network according to claim 21, wherein the message is an ISUP message selected from the group consisting of USR and APM.

24. The communications network according to claim 21, wherein the session message is selected from the group consisting of SIP and SIP-T.

25. The communications network according to claim 24, wherein the session message includes an INFO session communications network.

26. The communications network according to claim 24, wherein the initial value is 1, the initial value is applied to the session message, and the session message includes a session method selected from the group consisting of INFO and PRACK.
